(19) United States
(12) Patent Application Publication
(10) Pub. No.: US 2015/0169089 A1
(43) Pub. Date: Jun. 18, 2015

(54) Surface Protection Film and Method of Making a Protection Film for a Touch Screen

(71) Applicant: Pedco, LLC, Chandler, AZ (US)

(72) Inventors: Patrick L. Dixon, Gold Canyon, AZ (US); Jacob M. Dixon, Gilbert, AZ (US)

(73) Assignee: Pedco, LLC, Chandler, AZ (US)

(21) Appl. No.: 14/104,554

(22) Filed: Dec. 12, 2013

(51) Int. Cl. G06F 3/041; G06F 1/16; B32B 38/00; B32B 37/24; B32B 37/12; G06F 3/047; H04B 1/3888

(52) U.S. Cl. CPC G06F 3/041; G06F 3/047; G06F 1/1656; H04B 1/3888; B32B 37/24; B32B 37/12; B32B 38/0004; B32B 2037/243; B32B 2038/0076; B32B 2255/26; B32B 2307/412; B32B 2307/584; B32B 2310/0831; B32B 2405/00; B32B 2571/00

(57) ABSTRACT

A protection film for a touch sensitive screen includes an adhesive substrate cut according to a shape of the touch sensitive screen. The adhesive substrate is disposed over a temporary liner. The adhesive substrate is transparent. A transparent polymer material is dispensed over the adhesive substrate. The transparent polymer material includes a flat surface formed by nature of the transparent polymer material flowing due to gravity and a convex edge formed by nature of a surface tension of the transparent polymer material. A coating is formed over the transparent polymer material. The transparent polymer material is cured. The temporary liner is removed after curing the transparent polymer material, and the protection film is attached to the touch sensitive screen. The protection film includes a thickness ranging from 0.2 millimeters (mm) to 1.5 mm. The touch sensitive screen remains functional with the protective film attached to the touch sensitive screen.

### FIELD OF THE INVENTION

The present invention relates in general to an electronic device accessory, and more particularly, to a surface protection film for an electronic device.

### BACKGROUND OF THE INVENTION

Electronic devices include surfaces which are susceptible to damage, such as scratches or cracks. Portable electronic devices are particularly susceptible to being damaged by dropping or from contact with hard materials. Both the internal components and external surface of portable electronic devices can be damaged by an impact with a hard surface. The integrity of the surfaces of an electronic device is important for functionality of the device and also for visual appeal of the device. Damaged electronic devices are expensive to repair or replace.

Various types of electronic device accessories are available to protect the external surfaces and screen and the internal components from damage. Accessories such as protective cases made of plastic, fabric, wood, metal, and other materials are available for most portable electronic devices. Some protective cases may fit over an electronic device to temporarily cover the screen while the device is not in use. Other protective cases fit around an electronic device and leave the display screen uncovered for use while the case is on the device. Protection films are available to cling, attach, or adhere to surfaces of an electronic device to cover the surfaces and protect the surfaces from minor scratches.

Many electronic devices include display screens or surfaces made of glass, coated glass, chemically strengthened glass, plastic, rubber, metal, natural materials, or a combination of materials. Display screens on many electronic devices are sensitive to touch where the touch screen is the primary user interface for the device. Touch screens are found in many portable electronic devices, such as cellular phones, audio players, hand-held video game systems, digital cameras, laptop computers, tablet computers, global positioning systems (GPS), digital watches, smart watches, and other personal electronic devices. Cracks or scratches on the touch screen may interfere with the functionality of the touch screen and also diminish the appearance of the touch screen display. Screen protection films, in particular, are used to protect display screens from fingerprints and minor scratches caused by normal daily use.

One type of currently available screen protection film is applied to an electronic device using a dry application method. Typically, pressure sensitive adhesive is used to apply and adhere the protection film to the device. Thin protection films incorporating pressure sensitive adhesive are prone to application errors. A user may have difficulty positioning a flimsy or thin film because the film folds easily and sticks to itself. A thin protection film is difficult to press and smooth onto the device because bubbles and creases are easily formed. As the protection film is pressed onto the device, air or debris can become trapped under the film. Trapped air or debris and creasing result in an uneven surface and can interfere with the function of a touch sensitive screen or create an undesirable appearance.

Another type of currently available screen protection film is applied to an electronic device using a wet application method. The wet application method uses a liquid solution to apply the film to the electronic device. The film is sprayed or soaked in the liquid solution prior to applying the film to the electronic device. The wet film is placed on the screen of the device and pressed onto the device to smooth the film and to remove any air bubbles from between the film and the screen. The wet application method introduces a risk of damaging the electronic device if liquid seeps into the interior of the device. After the film is in place, the film is dried on the screen. The film is intended to be permanently attached to the electronic device. Removal of a permanent protective film leaves an adhesive residue on the screen. Adhesive residue is often difficult to remove from a device. Residue remaining on a screen or damage to the screen during removal of a screen protection film can interfere with the function of a touch sensitive screen or create an undesirable appearance and can further reduce the value of the device.

Screen protection films currently range in thickness from about 0.076 millimeters (mm) (about 3 mils, where 1 mil is equivalent to 0.001 inch) to about 0.381 mm (about 15 mils). Screen protection films with a thickness of up to approximately 0.381 mm (about 15 mils) primarily prevent small scratches and light abrasions on the screen. Most screen protection films provide minimal protection from shock or impact. Current manufacturing methods for screen protectors are limited in capability to produce screen protection films with greater thickness and which also maintain the touch sensitive features and clarity of a display screen.

### SUMMARY OF THE INVENTION

A need exists for a surface protection film which provides increased mechanical protection for an electronic device and which protects a touch sensitive display screen while maintaining the function of the touch screen. Accordingly, in one embodiment, the present invention is a method of making a protection film for a touch sensitive screen comprising the steps of providing an adhesive substrate, cutting the adhesive substrate according to a shape of the touch sensitive screen, dispensing a transparent polymer material over the adhesive substrate. The transparent polymer material includes a flat surface and a convex edge. The method further includes the step of curing the transparent polymer material. The protection film includes a thickness ranging from 0.2 millimeters (mm) to 1.5 mm.

In another embodiment, the present invention is a method of protecting a surface of an electronic device comprising the steps of providing a substrate layer, cutting the substrate layer according to a shape of the surface of the electronic device, dispensing a transparent polymer material over the substrate layer, and curing the transparent polymer material. A surface of the transparent polymer material includes a flat portion and a convex portion.

In another embodiment, the present invention is a protective film for a touch sensitive screen comprising a substrate layer and an adhesive layer disposed over a first surface of the substrate layer. A transparent polymer material is disposed over a second surface of the substrate layer opposite the first surface. The transparent polymer material includes a flat surface and a convex edge. The protective film includes a thickness ranging from 0.2 millimeters (mm) to 1.5 mm.

In another embodiment, the present invention is a protective film for a surface of an electronic device comprising a substrate layer and an adhesive layer disposed over a first surface of the substrate layer. A polymer material is disposed over a second surface of the substrate layer opposite the first surface. The polymer material includes a flat portion and a convex portion.

### BRIEF DESCRIPTION OF THE DRAWINGS

FIG. 1 illustrates an electronic device including a screen protector adhered to a display screen;

FIGS. 2a-2f illustrate a process of making a protection film or screen protector for a touch sensitive display screen;

FIG. 3 illustrates a process of applying a protection film or screen protector to an electronic device;

FIG. 4 illustrates an alternative process of applying a protection film or screen protector to an electronic device;

FIGS. 5a-5d illustrates a protection film or screen protector applied to an electronic device; and

FIG. 6 illustrates a process of removing a protection film or screen protector from an electronic device.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, those skilled in the art will appreciate that the description is intended to cover alternatives, modifications, and equivalents as may be included within the spirit and scope of the invention as defined by the appended claims and the claims' equivalents as supported by the following disclosure and drawings.

Personal electronic devices are used in many ways that can cause damage to the surface or to internal components of the device. Users may require additional protection over what current protection films provide. A protection film or screen protector having a greater thickness provides increased protection for the screen and other surfaces of an electronic device. For display screens, the protection film provides high clarity for viewing a display and enhances the appearance of the display and the device. The protection film provides adequate mechanical protection of a display screen and allows for touch sensitive screens to be used while the protection film is applied to the touch sensitive screen. The protection film described herein optimizes the clarity and thickness of the protection film for protection of touch screens. The protection film is also customizable in shape, thickness, color, and transparency according to a user's needs for the electronic device or surface.

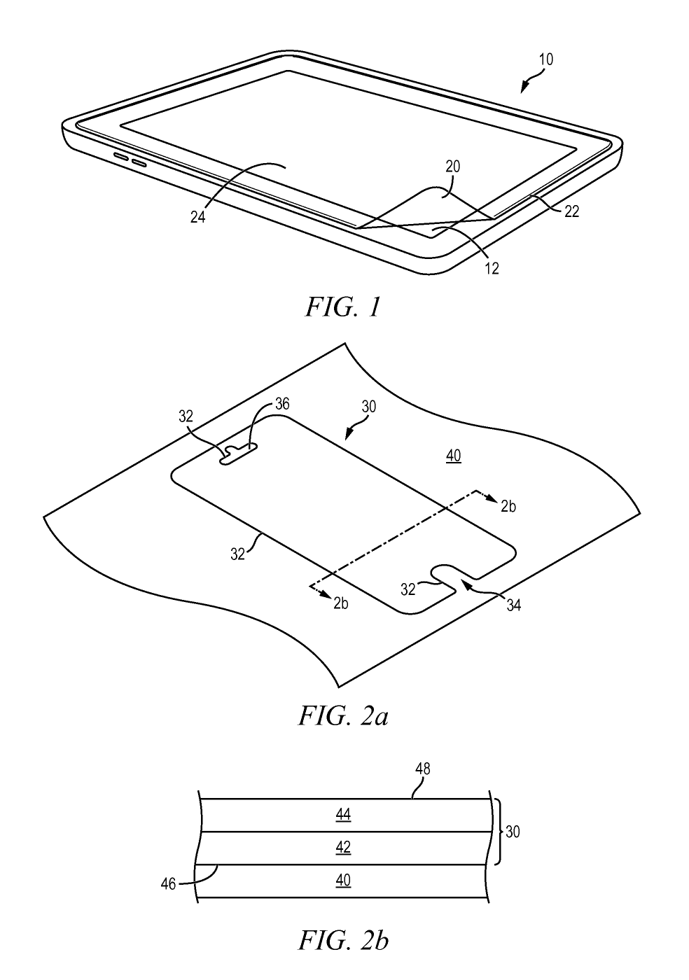

FIG. 1 illustrates an electronic device including a screen protector adhered to a display screen. An electronic device 10 includes a display screen 12 which is a touch sensitive screen. Electronic device 10 may be a cellular phone, audio player, hand-held video game system, digital camera, laptop computer, tablet computer, electronic reading device, GPS, digital watch, smart watch, or other personal electronic device. Electronic device 10 may be any device with a screen, including a non-portable system with a touch screen or non-touch screen, such as a display panel for machines or equipment. Screen protector 20 is applied directly to display screen 12 of electronic device 10 to cover display screen 12 and to protect display screen 12 from damage. Screen protector 20 adheres to display screen 12 to provide a robust, yet removable protective layer. Screen protector 20 is transparent or clear and allows for high visibility of display screen 12 through screen protector 20. In one embodiment, screen protector 20 includes a thickness of greater than about 0.2 mm (about 7.8 mils) and less than about 1.78 mm (about 70 mils). Screen protector 20 includes domed, convex, or rounded edges 22 along a perimeter of screen protector 20. For screen protectors 20 that include additional cut-outs or openings, each edge around the cut-outs or openings is also domed, similar to edges 22. Surface 24 of screen protector 20 is flat and smooth. Screen protector 20 is a protection film that does not interfere with the touch sensitive capabilities of display screen 12.

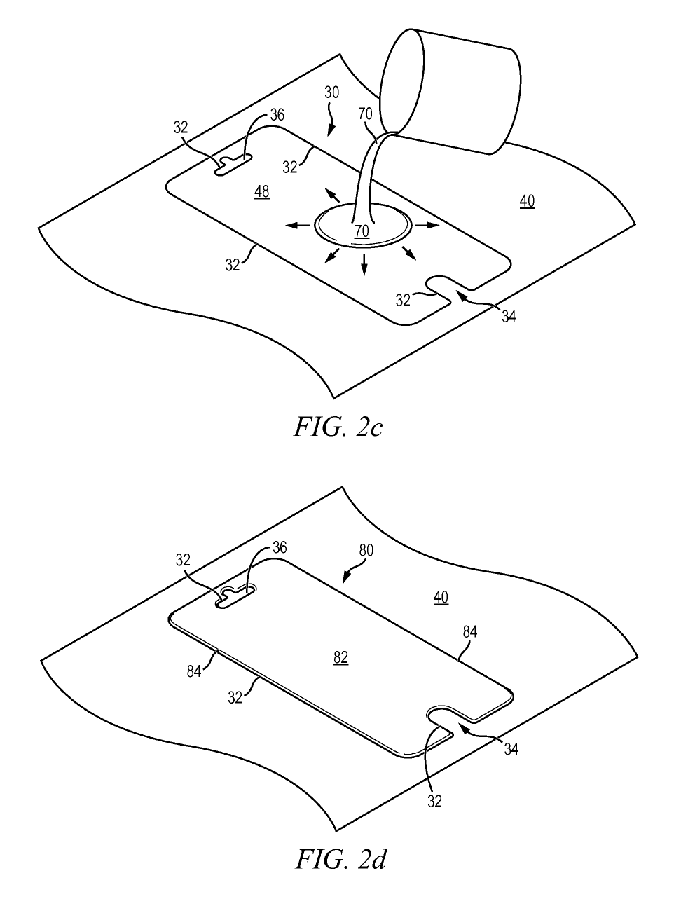

FIGS. 2a-2f illustrate a process of making a protection film or screen protector for a touch sensitive display screen or other surface. FIG. 2a shows an adhesive substrate 30 cut or formed into a shape to fit the surface of the intended electronic device. Adhesive substrate 30 includes edges 32 which define an area of adhesive substrate 30 which is part of the protective film. Adhesive substrate 30 matches the shape of a surface of an electronic device. The shape of adhesive substrate 30 is customizable according to each different electronic device design and for various sizes of protection film. Adhesive substrate 30 is formed or cut into any desired shape using a die cutting method, such as a rotary die, or by plotter cutting, laser cutting, or other suitable method. In one embodiment, the dimensions of adhesive substrate 30 are customized for a cellular phone, and adhesive substrate 30 is approximately 120 mm in length and 60 mm in width. In another embodiment, the dimensions of adhesive substrate 30 are customized for a tablet computer, and adhesive substrate 30 is approximately 240 mm in length and 160 mm in width. In yet another embodiment, the dimensions of adhesive substrate 30 are customized for a large surface, for example over one meter in length or width.

Electronic devices often include features on the surfaces of the device which need to remain uncovered from a protective film or screen protector. Buttons, keys, microphones, speakers, jacks, camera lenses, or other features disposed on the device surface are accommodated by forming cut-outs in adhesive substrate 30. Edges 32 define cut-outs or openings 34 and 36 which correspond to features on the electronic device which are not directly covered by the protective film. Cut-outs 34 and 36 are formed during the process of cutting adhesive substrate 30 into a desired shape. Cut-outs 34 and 36 are examples of openings formed in adhesive substrate 30 for a specific electronic device design. In one embodiment, cut-out 34 is approximately 13 mm in length and 13 mm in width. In one embodiment, cut-out 36 is approximately 16 mm in length and ranges from 5 mm to 8 mm in width, and cut-out 36 is positioned a distance approximately 2.5 mm from edge 32. Adhesive substrates 30 for each different electronic device design include custom edges 32 and various cut-outs, such as cut-outs 34 and 36, if needed. Additional cuts, openings, or slits are formed in adhesive substrate 30 as needed to fit the surface of a device. For example, cuts or slits are formed for fitting adhesive substrate 30 onto a three dimensional (3D) surface.

Adhesive substrate 30 is temporarily attached to a liner or release liner 40. Release liner 40 is a sacrificial layer or temporary substrate for transporting adhesive substrate 30 prior to using the protection film. Release liner 40 is easily removable from adhesive substrate 30. In one embodiment, release liner 40 is coated with a material such as silicone to allow easier removal of adhesive substrate 30 from release liner 40. Release liner 40 may be a plastic film, such as polyethylene terephthalate (PET), acetate film, polypropylene, polyurethane, polyethylene (PE), ultra high molecular weight PE (UHMW), polyamide, polytetrafluoroethylene (PTFE), polyvinyl fluoride (PVF), polyvinyl alcohol (PVA), polyvinyl chloride (PVC), polystyrene, acrylic, or other suitable substrate material.

In one embodiment, adhesive substrate 30 is die cut into the desired shape after being attached to release liner 40. Release liner 40 has a length and width which are greater than adhesive substrate 30 after adhesive substrate 30 is die cut. Pieces of adhesive substrate 30, which are not needed for the particular shape of the protection film, are peeled off of release liner 40 and discarded. In another embodiment, adhesive substrate 30 and release liner 40 are both die cut together and adhesive substrate 30 and release liner 40 have the same shape and size after being die cut.

FIG. 2b shows a cross section of adhesive substrate 30 disposed on release liner 40. Adhesive substrate 30 includes an adhesive layer or adhesive 42 and a substrate layer or substrate 44. Substrate 44 is disposed over adhesive 42, and adhesive 42 is disposed over release liner 40. Adhesive substrate 30 includes bottom surface 46, which is also a bottom surface of adhesive 42. Adhesive substrate 30 is temporarily attached or adhered to release liner 40 at surface 46 of adhesive substrate 30. Adhesive substrate 30 also includes top surface 48 opposite bottom surface 46. Surface 48 of adhesive substrate 30 is also a top surface of substrate 44. In one embodiment, surface 48 is non-adhesive. Both adhesive 42 and substrate 44 are optically transparent or clear.

Adhesive 42 may be a pressure-sensitive adhesive, self-wetting adhesive, or other type of adhesive. Adhesive 42 may be silicone, acrylic, modified acrylic, or other suitable adhesive. In one embodiment, adhesive 42 is optically clear or transparent. Adhesive 42 is applied to substrate 44 prior to adhering adhesive substrate 30 to release liner 40. Adhesive 42 is applied to substrate 44 by spraying, extruding, rolling, coating, laminating, melting, or other dispensing method. Adhesive 42 may be removable or permanent. Removable adhesive is adhesive which is able to be peeled off of a device surface, such as by hand and without harsh tools or materials, and without damaging or leaving residue on the surface of the device. In one embodiment, adhesive 42 is a removable pressure sensitive clear acrylic. Adhesive substrate 30 temporarily adheres to release liner 40, which contacts surface 46 of adhesive 42. Release liner 40 is configured to be removed from surface 46 of adhesive 42 prior to using the protection film. The thickness of adhesive 42 is selected based on the type of surface to be covered by protection film and based on the thickness of the protection film. In one embodiment, adhesive 42 has a thickness ranging from approximately 0.013 mm (0.5 mil) to approximately 0.127 mm (5 mils). In another embodiment, adhesive 42 has a thickness of less than approximately 0.013 mm (0.5 mil) or greater than 0.127 mm (5 mils).

Substrate 44 provides a surface over which adhesive 42 and additional layers are applied. Substrate 44 may be PET, acetate film, polypropylene, urethane, polyurethane, PE, UHMW PE, polyamide, PTFE, polycarbonate, PVF, PVA, PVC, polystyrene, acrylic, or other polymer material. Substrate 44 is optically clear or transparent where the protection film is to be used as a screen protector. In one embodiment, substrate 44 is a high grade PET film with a light transmission of 90% or greater. In another embodiment, substrate 44 is an optically transparent PET and has a light transmission of at least 80%. Substrate 44 is either opaque, translucent, or transparent where the protection film is to be used as a surface protector for a non-display screen surface. Substrate 44 includes a single layer of material or includes a plurality of layers of material laminated together to form substrate 44. Substrate 44 may include additional properties, such as transmissive polarization or privacy polarization, anti-glare, matte effect, or ultraviolet (UV) protection.

The thickness of substrate 44 is selected based on the type of surface to be covered by protection film and based on the thickness of the protection film. In one embodiment, substrate 44 has a thickness ranging from approximately 0.025 mm (1 mil) to approximately 0.127 mm (5 mils). In another embodiment, substrate 44 has a thickness of less than 0.025 mm (1 mil) or greater than 0.127 mm (5 mils). Additional substrate layers, similar to substrate 44, may be disposed between adhesive 42 and substrate 44 or over surface 48 of substrate 44. Additional adhesive materials, similar to adhesive 42, may be disposed between adhesive 42 and substrate 44 or over surface 46 of adhesive 42.

FIG. 2c shows the step of dispensing a material 70 over surface 48 of adhesive substrate 30. Adhesive substrate 30 is placed on a horizontal or flat surface. Material 70 is dispensed over surface 48 of adhesive substrate 30. The step of dispensing material 70 over adhesive substrate 30 can be completed by a manual pouring process or automatically using an automated dispensing system. Material 70 may be clear multi-part urethane, multi-part epoxy, resin, or other clear or transparent material. In one embodiment, material 70 is a two-part clear urethane resin. A two-part urethane is made by mixing a first base material, such as a resin, with a second base material, such as a hardener, to form a liquid mixture, which later hardens during a curing step. In another embodiment, material 70 is a two-part clear urethane modified or diluted to decrease the viscosity of the urethane or to thin the urethane during the liquid state, prior to curing.

In one embodiment, material 70 is optically transparent or clear. Material 70 can be tinted with a transparent color for a colored transparent protection film. Alternatively, material 70 can be tinted or dyed with an opaque or translucent color for protection films designed for non-screen surfaces, such as a back surface or side surface of a device. For screen protectors, material 70 is selected to have a light transmission of at least 60%. Material 70 may include additives to provide anti-glare, matte effect, polarization, UV protection, or other visual effects. Material 70 is selected to have properties such as resistance to visible aging, yellowing, shrinking, and UV light degradation. Softer materials provide better scratch protection and impact protection. Harder materials provide a better appearance, smoothness, and feel of screen protector. Material 70 is selected to provide a hardness that produces a surface that feels smooth and appears visibly smooth to the unaided eye, but also resists fingerprints and scratches.

Material 70 is a viscous liquid prior to curing and has high internal cohesion properties. During the step of dispensing material 70 over adhesive substrate 30, material 70 naturally flows over and across adhesive substrate 30 up to edges 32. Because adhesive substrate 30 is disposed on a horizontally flat surface, material 70 is able to flow laterally or horizontally, or in the direction indicated by the arrows in FIG. 2c. Material 70 spreads over surface 48 of adhesive substrate 30 by nature of material 70 flowing due to the force of gravity on material 70. Material 70 flows around cut-outs 34 and 36 filling the surface area of adhesive substrate 30 and covering adhesive substrate 30. Additionally, a tool may optionally be used to spread material 70 across surface 48 of adhesive substrate 30 or to assist material 70 in flowing across surface 48 of adhesive substrate 30. The effect of gravity on material 70 causes material 70 to evenly or uniformly distribute over adhesive substrate 30. The surface tension of material 70 allows material 70 to flow up to edges 32 but not over edges 32 of adhesive substrate 30.

Material 70 forms a flat surface across adhesive substrate 30 except at edges 32. The high viscosity or internal cohesion of material 70 forms a convex meniscus at edges 32 of adhesive substrate 30. In other words, material 70 spreads thinner as material 70 reaches edges 32 of adhesive substrate 30 and forms a natural convex shape along edges 32. The surface tension of material 70 prevents material 70 from flowing over edges 32 of adhesive substrate 30. The amount or volume of material 70 is selected according to the surface area of adhesive substrate 30 such that material 70 spreads across surface 48, but not over edges 32. Additionally, heat may be applied to material 70 as material 70 flows over adhesive substrate 30 in order to temporarily reduce the viscosity or to thin material 70 and improve the flow of material 70 over adhesive substrate 30. Material 70 is cured and can be cured with or without UV light or heat. Material 70 cures into a flexible layer and bonds to substrate 44.

FIG. 2d illustrates a protection film 80 disposed on release liner 40. After material 70 is cured, protection film 80 is formed and remains adhered to release liner 40. Protection film 80 is a flexible structure. Protection film 80 includes a smooth top or main surface 82, which is formed by the natural flow of material 70 during the dispensing of material 70. Main surface 82 includes a substantially flat surface except along a perimeter of protection film 80 at edges 84. Protection film 80 includes a domed, convex, or rounded surface at edges 84. Edges 84 slope or curve from the flat main surface 82 downward to edges 32 as a result of or by nature of the surface tension of material 70 which forms a convex meniscus over adhesive substrate 30. As a result, the thickness of material 70 decreases at edges 84 of protection film 80. Cut-outs 34 and 36 remain devoid of material 70 to allow portions of a device to remain uncovered from protection film 80. Protection film 80 also includes domed, convex, or rounded edges around cut-outs 34 and 36. Protection film 80 may include additional cutouts, openings, or slits. Material 70 flows up to but not over the cutouts, openings, and slits formed in adhesive substrate 30.

Protection film 80 is ready for transport to an end user. Release liner 40 remains attached to protection film 80 during transport, and can easily be removed from protection film 80. Protection film 80 remains disposed on release liner 40 until a user is ready to apply protection film 80 to an electronic device. Optionally, a cap sheet is removably attached to main surface 82 of protection film 80 to protect main surface 82 during transport and during application of protection film 80 to a surface. A cap sheet is removed after protection film 80 is applied to a device.

FIG. 2e shows a cross section of protection film 80 disposed on release liner 40. The layers of adhesive 42, substrate 44, and material 70 together comprise protection film 80. Protection film 80 includes adhesive 42 applied directly to substrate 44. In one embodiment, adhesive 42 has a thickness of approximately 0.102 mm (4 mils). Material 70 is applied directly to surface 48 of substrate 44 opposite adhesive 42. Therefore, material 70 is disposed over and in direct contact with substrate 44. In one embodiment, material 70 has a thickness of approximately 1.270 mm (50 mils). Substrate 44 is disposed over and in contact with adhesive 42. In one embodiment, substrate 44 has a thickness of approximately 0.051 mm (2 mils). Protection film 80 is formed on release liner 40 and temporarily adheres to release liner 40. In one embodiment, protection film 80 has a total thickness of approximately 1.422 mm (56 mils). Surface 46 of adhesive 42 is in contact with release liner 40 such that adhesive 42 is removably attached to release liner 40.

Protection film 80 includes main surface 82 which is substantially flat up to edges 84. Main surface 82 is substantially flat due to the effect of gravity on material 70 which causes material 70 to evenly distribute over surface 48 of adhesive substrate 30. The slope of edges 84 depends on the viscosity of material 70, the surface area or size of adhesive substrate 30, and the amount of material 70 dispensed over adhesive substrate 30. A thicker layer of material 70 has a greater height and cause higher convex doming of material 70 which increases the slope at edges 84. For example, where material 70 has a thickness of approximately 1.270 mm (50 mils), a distance D of the slope at edges 84 is approximately 3 mm (118 mils). In other words, distance D from the flat portion of main surface 82 to edge 32 is approximately 3 mm (118 mils). A thinner layer of material 70 has a lesser height and decreased doming at edges 84. For example, where a thinner, less viscous material 70 is used, the slope at edges 84 is more gradual. In one embodiment, material 70 has a thickness between 0.381 mm (15 mils) and 1.270 mm (50 mils), distance D of the slope at edges 84 is greater than 3 mm (118 mils).

FIG. 2f shows a cross section of an alternative protection film 80 including additional coating or layer 90. Additional coatings or layers 90 are optionally formed over material 70. Coating 90 is applied to surface 82 of protection film 80 by lamination, liquid application, or other suitable method. Coating 90 may include an oleophobic coating, anti-glare coating, matte coating, transmissive polarization or privacy polarization, UV protection, or a material having other effects. Coating 90 may be used to seal material 70 and reduce the porosity of surface 82. In one embodiment, coating 90 is a silicone layer formed over surface 82 to seal material 70 in order to limit the amount of oils and contaminates that are absorbed by material 70 during use of screen protector 80. Coating 90 reduces the discoloration caused by oils and contaminates introduced by fingers contacting the surface of protection film 80. Coating 90 improves the fingerprint resistance properties of protection film 80.

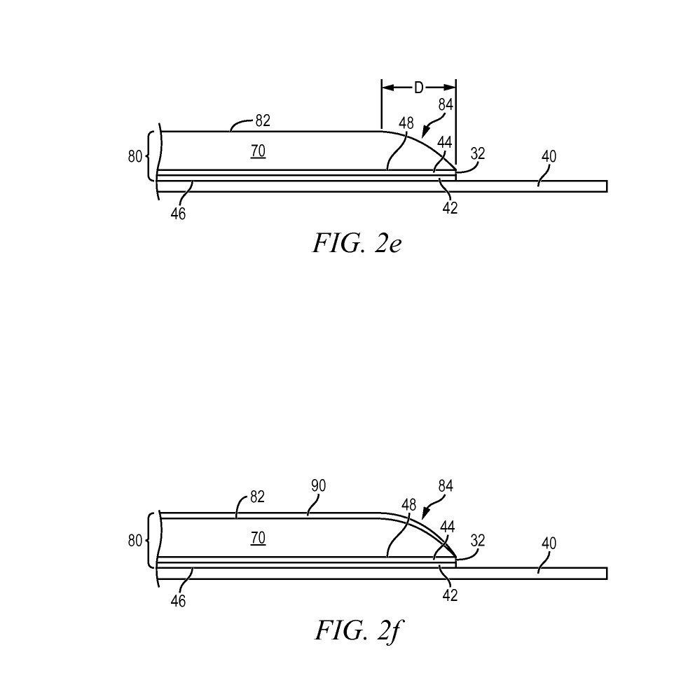

FIG. 3 shows a process of applying protection film 80 to electronic device 100. Electronic device 100 includes display surface 102 which is covered by protection film 80. Protection film 80 is removed from release liner 40 by peeling away release liner 40. To apply protection film 80 to electronic device 100, protection film 80 is aligned over display surface 102. A first end of protection film 80 is aligned with a first end of electronic device 100. Cut-out 34 corresponds to button 104 of electronic device 100, and cut-out 36 corresponds to component 106 of electronic device 100. Cut-outs 34 and 36 provide openings for button 104 and component 106 to remain uncovered and uncovered from protection film 80.

Protection film 80 is flexible, yet rigid enough to prevent folding and creasing of protection film 80 after removal from release liner 40. Because protection film 80 is flexible or bendable, protection film 80 can be applied starting at one end or corner of electronic device 100. Protection film 80 is slightly bent initially as protection film 80 makes contact with a portion of display surface 102. Protection film 80 is smoothed and flattened onto display surface 102 until protection film 80 is completely adhered to display surface 102. In one embodiment, adhesive 42 is self-wetting such that adhesive surface 46 of protection film 80 adheres to display surface 102 with light or minimal pressure. In another embodiment, adhesive 42 is pressure sensitive and a user applies pressure to protection film 80 while applying protection film 80 to display surface 102. Protection film 80 is applied by hand without any tools. Alternatively, a smoothing tool may be used to apply pressure to protection film 80 during or after application. Protection film 80 is applied quickly, in under one minute, with or without tools. The quick application time reduces the risk of adhesive surface 46 of protection film 80 becoming contaminated by dust, dirt, or other environmental contaminants.

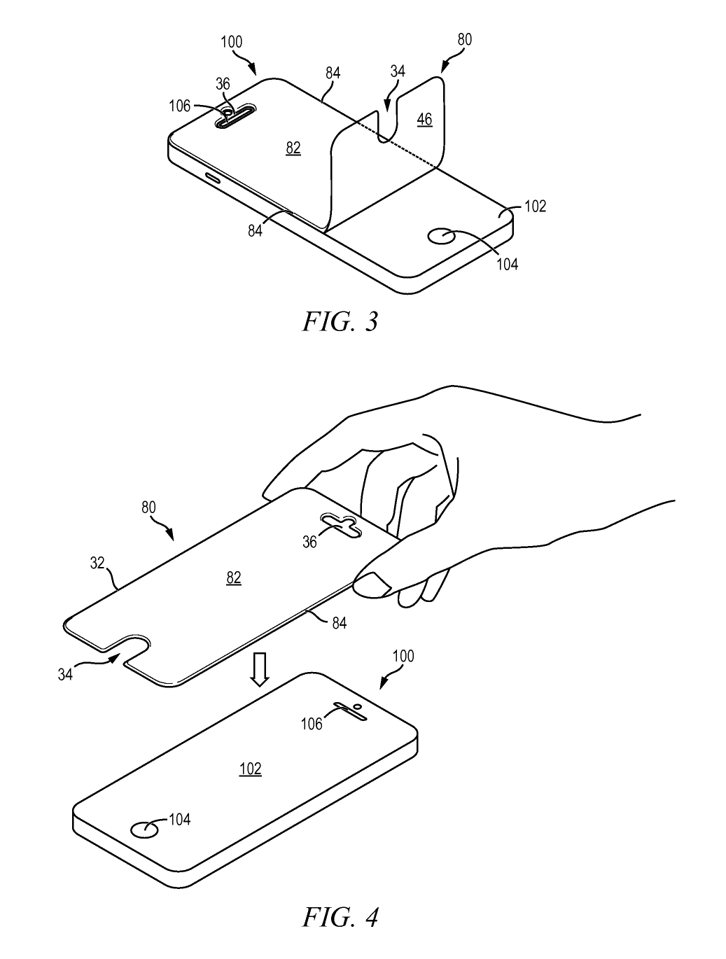

FIG. 4 shows another process of applying protection film 80 to electronic device 100. While protection film 80 is flexible, protection films 80 with smaller dimensions, such as protection films for cellular phones, can be applied without bending protection film 80. Protection film 80 is removed from release liner 40 by peeling away release liner 40. A user may hold protection film 80 at edges 32. By holding protection film 80 at edges 32, adhesive surface 46 remains untouched. Protection film 80 may bend slightly when held by edges 32, but protection film 80 is stiff or rigid enough to not buckle, fold, or crease during application. The user aligns protection film 80 over display surface 102 of electronic device 100. Cut-out 34 corresponds to button 104 of electronic device 100, and cut-out 36 corresponds to component 106 of electronic device 100. Cut-outs 34 and 36 provide openings for button 104 and component 106 to remain uncovered and exposed from protection film 80. After aligning protection film 80 over display surface 102, the user applies light pressure to protection film 80 to press protection film 80 on display surface 102. Surface 46 of adhesive 42 adheres to display surface 102. Protection film 80 is applied by hand without any tools. Alternatively, a smoothing tool may be used to apply light pressure to protection film 80 during or after application. Protection film 80 is applied quickly, in under one minute, with or without tools. The quick application time reduces the risk of adhesive surface 46 of protection film 80 becoming contaminated by dust, dirt, or other environmental contaminants.

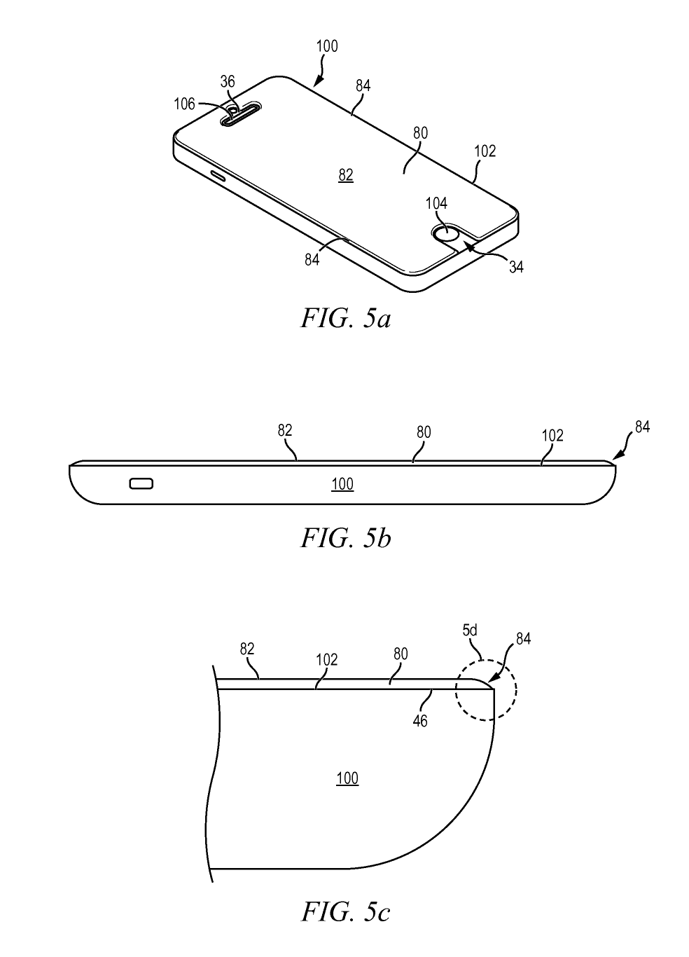

FIG. 5a shows protection film 80 applied to electronic device 100. Protection film 80 includes customized dimensions for display surface 102 of electronic device 100. Protection film 80 covers most of display surface 102. Cut-out 34 allows button 104 of electronic device 100 to remain uncovered and unencumbered by protection film 80. Cut-out 36 allows component 106 of electronic device 100 to remain uncovered and unencumbered by protection film 80. Protection film surrounds button 104 and component 106 to leave button 104 and component 106 uncovered. Although component 106 and button 104 remain uncovered, component 106 and button 104 are indirectly protected by the surrounding protection film 80. The thickness of protection film 80 adjacent to and around component 106 and button 104 provides a raised surface which can reduce unintended impact to component 106 and button 104.

Main surface 82 of protection film 80 provides a smooth, clear surface through which a user can see the screen on display surface 102. Most electronic device display screen surfaces include a display portion and an inactive or non-display portion. The non-display portion typically surrounds the screen portion around a perimeter of the screen portion. Both the display portion and non-display portion of electronic device 100 are covered by a glass or other hard material. Protection film 80 uniformly adheres to the glass which covers the display portion and non-display portion of display surface 102. Protection film 80 provides good visibility through protection film 80 and enhances the appearance of the surface to which protection film 80 is applied. In one embodiment, protection film 80 provides magnification of the device surface. Protection film 80 maintains visibility of a display screen and maintains the touch sensitive capability of a touch sensitive screen. Edges 84 of protection film 80 provide magnification directly underneath edges 84, which are convex in shape. In one embodiment, the dimensions of protection film 80 are selected such that edges 84 are disposed outside the area of the display screen of electronic device 100 when protection film 80 is applied. Main surface 82 aligns over the display portion. Edges 84 align outside the display portion and over the non-display portion. Therefore, the screen portion of display surface 102 is covered by the flat main surface 82, and the non-display portion at a perimeter of display surface 102 is covered by edges 84.

Protection film 80 can be used to cover and protect touch sensitive display screens, non-touch sensitive display screens, or non-display surfaces of an electronic device. In one embodiment, display surface 102 is a touch sensitive screen. Protection film 80 disposed on display surface 102 does not hinder or impair the touch sensitive capability of display surface 102. A user touches main surface 82 of protection film 80 to interact with the touch sensitive features on display surface 102 of electronic device 100. Protection film 80 including a thickness of approximately 1.524 mm (60 mils) or less, maintains the touch sensitivity of display surface 102. Protection film 80 including a thickness ranging from approximately 0.381 (15 mils) to 1.524 mm (60 mils) provides a substantial increase in mechanical protection over existing protective films. For example, protection film 80 having a thickness of 1.422 mm (56 mils) provides at least four to five times the thickness of typical protective films. Protection film 80 withstands a greater impact force on display surface 102. Therefore, protection film 80 substantially reduces the risk of damage to display surface 102 by dropping, contact with hard materials, or other impact.

Material 70 selected for the top layer of protection film 80 is selected to balance the need for impact absorption, scratch resistance, and fingerprint resistance with the hardness that provides a clear appearance and a smooth tactile feel similar to glass. In one embodiment, the top layer of protection film 80 is clear urethane. Alternatively, coating 90 is applied to surface 82 of protection film 80. Protection film 80 resists scratches and fingerprints and is easily wiped clean using a standard screen-cleaning cloth. Protection film 80 is transparent and has optical transmission properties that do not distort the image on display screen 102.

In an alternative embodiment, protection film 80 is a protective skin for a non-display surface of electronic device 100. For example, protection film 80 is formed to cover the sides or back surface of electronic device 100. Protection film 80 includes a thickness of approximately 0.356 (14 mils) or greater for covering and protecting non-display surfaces of electronic device 100. For non-touch sensitive surfaces and non-display surfaces, protection film 80 can be thicker for additional mechanical protection. Increasing the thickness of protection film 80 further increases the impact resistance provided by protection film 80. Protection film 80 is formed thicker by dispensing additional material 70 over adhesive substrate 30 during the step shown in FIG. 2c.

Protection film 80 is suitable for any size or shape of electronic device or surface. The dimensions of protection film 80 can be selected by simply changing the size and shape of adhesive substrate 30 and the quantity of material 70 dispensed over adhesive substrate 30. The dimensions of protection film 80 can be customized cellular phones, audio players, hand-held video game systems, digital cameras, laptop computers, tablet computers, GPS, digital watches, smart watches, and other personal electronic devices or screens. Protection film 80 can be applied to curved or flexible surfaces. Additionally, protection film 80 can be customized for 3D surfaces. For example, additional slits, openings, or grooves are formed during the dispensing step by material 70 flowing around and up to edges of cut-outs or slits formed in adhesive substrate 30. The cut-outs or slits in adhesive substrate 30 leave areas of protection film 80 devoid of material 70 in order for protection film 80 to bend around 3D surfaces. Alternatively, after material 70 is cured onto adhesive substrate 30, cuts, slits, or openings can be formed in protection film 80 in order for protection film 80 to bend around 3D surfaces. Additional cuts, slits, or openings are formed using a knife or blade, or using a die cutting method, such as a rotary die, or by plotter cutting, laser cutting, or other suitable method.

FIG. 5b shows a cross section of protection film 80 applied to electronic device 100. Protection film 80 disposed on display surface 102 of electronic device 100 provides physical protection of display surface 102 from scratches. Protection film 80 also provides mechanical protection from direct impact to display surface 102. Protection film 80 provides a layer over display surface 102 that is thicker than typical protective films and has greater impact absorption characteristics. Additionally, protection film 80 provides an enhanced feel and appearance due to the rounded surface at edges 84. The domed, convex, or rounded surface at edges 84 results in a decreasing thickness as protection film 80 approaches the edge of display surface 102. The sloping or rounded shape of edges 84 make a smooth transition from protection film 80 to display surface 102. When handling electronic device 100 with protection film 80, a user is unlikely to feel the seam or interface where protection film 80 ends on display surface 102.

FIG. 5c shows a close up of an edge of electronic device 100 including protection film 80. Protection film 80 is formed with dimensions to match display surface 102, so protection film 80 fits closely to the edges of display surface 102. Further, the slope at edges 84 enhances the adherence of protective film to electronic device 100, because edges 84 are less likely to catch on or rub against objects during regular use of electronic device 100. Edges 84 have a reduced height along the perimeter of display surface 102. The reduced height at edges 84 reduces the area of protection film 80 at edges 84 that come into contact with a user's hand or other object. The sloping or rounded shape of edges 84 cause objects to slide over edges 84, rather than push into edges 84. Therefore, edges 84 are less likely to be accidentally peeled off of display surface 102. Accordingly, protection film 80 with sloped or rounded edges 84 remains adhered to display surface 102 better than protective layers having non-sloped edges.

FIG. 5d shows an enlarged view of the edge of protection film 80 disposed on electronic device 100. Protection film 80 is applied directly to display surface 102 of electronic device 100. Adhesive 42 is a bottom layer of a multi-layer protection film 80. Surface 46 of adhesive is in direct contact with display surface 102 and adheres to display surface 102. In one embodiment, adhesive 42 has a thickness of approximately 0.102 mm (4 mils). Substrate 44 is a middle layer of a multi-layer protection film 80. Substrate 44 is disposed over and in contact with adhesive 42. In one embodiment, substrate 44 has a thickness of approximately 0.051 mm (2 mils). Material 70 is a top layer of a multi-layer protection film 80, and alternatively, coating 90 is formed over material 70. Material 70 adheres to surface 48 of substrate 44 opposite adhesive 42. In one embodiment, material 70 has a thickness of approximately 1.270 mm (50 mils).

Protection film 80 has a selectable thickness according to the type of surface for which protection film 80 is intended. Protection film 80 can be any thickness greater than approximately 0.076 mm (3 mils). In one embodiment, protection film 80 includes a thickness T ranging from approximately 0.381 (15 mils) to 1.524 mm (60 mils). In another embodiment, protection film 80 includes a thickness T of approximately 1.422 mm (56 mils). For a touch sensitive display surface 102, thickness T of protective film 80 is less than 1.524 mm (60 mil). For a non-touch sensitive display surface 102, thickness T of protective film 80 can be greater than or less than 1.524 mm (60 mil).

Protection film 80 includes main surface 82 which is substantially flat up to edges 84. Main surface 82 is substantially flat due to the effect of gravity on material 70 which causes material 70 to evenly distribute over surface 48 of adhesive substrate 30. The slope of edges 84 depends on the viscosity of material 70, the surface area or size of adhesive substrate 30, and the amount of material 70 dispensed over adhesive substrate 30. The surface tension of material 70 causes the convex shape at edges 84. A thicker layer of material 70 has a greater height and cause higher convex doming of material 70 which increases the slope at edges 84. For example, where material 70 has a thickness of approximately 1.270 mm (50 mils), a distance D of the slope at edges 84 is approximately 3 mm (118 mils). In other words, distance D from the flat portion of main surface 82 to edge 32 is approximately 3 mm (118 mils). A thinner layer of material 70 has a lesser height and decreases the doming at edges 84. For example, where material 70 has a thickness between 0.381 mm (15 mils) and 1.270 mm (50 mils), distance D of the slope at edges 84 is greater than 3 mm (118 mils).

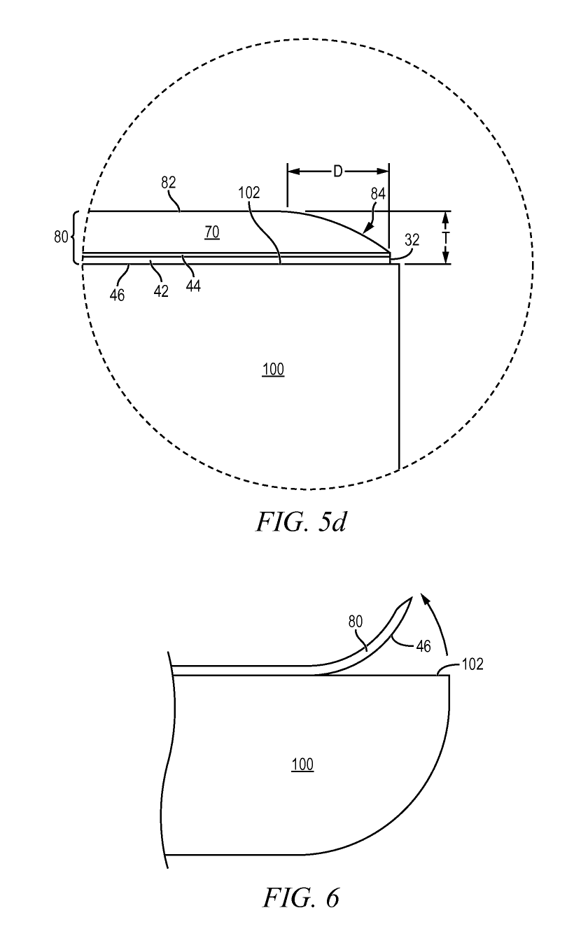

FIG. 6 shows a process of removing protection film 80 from an electronic device. Protection film 80 is removably attached to display surface 102 of electronic device 100. Adhesive 42 is selected to be long-lasting, yet non-permanent in order to leave no residue on display surface 102 after protection film 80 is removed. Protection film 80 is removed by peeling protection film 80 off of display surface 102. Display surface 102 does not need to be cleaned after protection film 80 is removed. In one embodiment, protection film 80 is removed and re-applied to display surface 102 or another surface having similar dimensions without significant degradation in adherence to the surface or appearance of protection film 80.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of making a protection film for a touch sensitive screen, comprising:
providing an adhesive substrate;
cutting the adhesive substrate according to a shape of the touch sensitive screen;
dispensing a transparent polymer material over the adhesive substrate, the transparent polymer material including a flat surface and a convex edge; and
curing the transparent polymer material, wherein the protection film includes a thickness ranging from 0.2 millimeters (mm) to 1.5 mm.

2. The method of claim 1, further including mixing a first material and a second material to form the transparent polymer material, wherein the transparent polymer material includes urethane.

3. The method of claim 1, further including curing the transparent polymer material with ultraviolet light or with heat.

4. The method of claim 1, wherein dispensing the transparent polymer material forms the flat surface by nature of the transparent polymer material flowing due to gravity and forms the convex edge by nature of a surface tension of the transparent polymer material.

5. The method of claim 1, further including disposing the adhesive substrate over a temporary liner.

6. The method of claim 1, further including forming a coating layer over the transparent polymer material.

7. A method of protecting a surface of an electronic device, comprising:
providing a substrate layer;
cutting the substrate layer according to a shape of the surface of the electronic device;
dispensing a transparent polymer material over the substrate layer; and
curing the transparent polymer material, a surface of the transparent polymer material including a flat portion and a convex portion.

8. The method of claim 7, further including forming an opening in the substrate layer, wherein the opening remains devoid of the transparent polymer material.

9. The method of claim 7, wherein dispensing the transparent polymer material forms the flat portion by nature of the transparent polymer material flowing due to gravity and forms the convex portion by nature of a surface tension of the transparent polymer material.

10. The method of claim 7, further including disposing an adhesive layer over a surface of the substrate layer, wherein the adhesive layer, substrate layer, and transparent polymer material form a protection film.

11. The method of claim 10, wherein the protection film includes a thickness less than 1.5 millimeters (mm).

12. The method of claim 10, further including attaching the protection film to the surface of the electronic device.

13. The method of claim 7, further including forming a coating layer over the transparent polymer material.

14. A protective film for a touch sensitive screen, comprising:
a substrate layer;
an adhesive layer disposed over a first surface of the substrate layer; and
a transparent polymer material disposed over a second surface of the substrate layer opposite the first surface, wherein the transparent polymer material includes a flat surface and a convex edge and wherein the protective film includes a thickness ranging from 0.2 millimeters (mm) to 1.5 mm.

15. The protective film of claim 14, wherein the transparent polymer material includes urethane.

16. The protective film of claim 14, further including the protective film disposed on the touch sensitive screen, wherein the touch sensitive screen remains functional with the protective film disposed on the touch sensitive screen.

17. The protective film of claim 14, wherein the substrate layer and adhesive layer are transparent.

18. The protective film of claim 14, wherein the adhesive layer includes a pressure sensitive adhesive.

19. The protective film of claim 14, further including an opening formed in the substrate layer and adhesive layer, wherein the opening is devoid of the transparent polymer material.

20. The protective film of claim 14, further including a coating formed over the transparent polymer material.

21. A protective film for a surface of an electronic device, comprising:
a substrate layer;
an adhesive layer disposed over a first surface of the substrate layer; and
a polymer material disposed over a second surface of the substrate layer opposite the first surface, wherein the polymer material includes a flat portion and a convex portion.

22. The protective film of claim 21, wherein the polymer material includes urethane.

23. The protective film of claim 21, wherein the substrate layer, adhesive layer, and polymer material are transparent.

24. The protective film of claim 21, wherein the protective film includes a thickness of greater than 0.2 millimeter (mm).

25. The protective film of claim 21, further including the protective film disposed on a touch sensitive screen, wherein the touch sensitive screen remains functional with the protective film disposed on the touch sensitive screen.
